(19) United States
(12) Patent Application Publication
(10) Pub. No.: US 2025/0162710 A1
(43) Pub. Date: May 22, 2025

(54) CONTRA-ROTATING COAXIAL ROTOR ASSEMBLY

(71) Applicant: Anthony Gerald FRISSORA, Littleton, CO (US)

(72) Inventor: Anthony Gerald FRISSORA, Littleton, CO (US)

(21) Appl. No.: 18/510,981

(22) Filed: Nov. 16, 2023

(51) Int. Cl. B64C 27/32

(52) U.S. Cl. CPC B64C 27/10; B64C 27/12

(57) ABSTRACT

A contra-rotating coaxial rotor assembly relating to aerial, as well as aquatic vehicles, comprising a central member, a first and second rotor assembly disposed thereon with a contra-rotating gear assembly coaxially disposed there between. The contra-rotating gear assembly comprising at least one gear operationally coupled to the first rotor assembly, at least one gear operationally coupled to the second rotor assembly, a collar having at least one protrusion, and at least one cogwheel affixed thereto. Each rotor assembly comprising a bearing, at least one length of mast, a rotor disposed along said length of mast, and a friction-reducer operationally engaged to the contra-rotating gear assembly. The second rotor assembly further comprising at least one power translation cogwheel operationally engaged with at least one power transmission cogwheel, which is itself connected to and driven by the output shaft from the engine.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### SPECIFICATION

### To all Whom it May Concern

Be it known that I, Anthony Gerald Frissora, a citizen of the United States, have invented new and useful improvements in a Contra-Rotating Coaxial Rotor Assembly as described in this specification.

### BACKGROUND OF THE INVENTION

Various types of propeller and bladed rotor systems, or assemblies, are known in the prior art, especially as they pertain to helicopter (or other aerial vehicles) and aquatic vehicular designs. Although this patent application will predominantly discuss the present invention in terms related to helicopters, and aerial vehicles as a whole, nothing herein should be understood as limiting the disclosure solely to non-aquatic vehicles, as the information set forth below may also be applicable to aquatic, and other, vehicles.

While the type of engine and rotor design may be dependent on the size of the vehicle, such as many smaller helicopters utilizing piston (or reciprocating) engines, the majority of helicopters nowadays use gas turbine or turboshaft engines, as they are smoother in operation, more powerful, less mechanically complex, and more reliable than the alternatives. Some of these vehicles may have a single such engine mounted underneath, or behind, the rotors while others may have dual engines mounted one on each side of the rotor mast. Alternatively, engines may be installed wherein the energy from the burning gas is used to spin a central turbine and driveshaft that powers the transmission (thereby allowing the engine to power the rotors) as opposed to the typical releasing of hot exhaust gas to give forward thrust.

Helicopters operate through the spinning of bladed rotor systems positioned above the vehicle's main body (or to the sides thereof) in order to create enough lift to counteract its weight, namely the gravitational effect on its mass. This occurs when air moving over a blade or a wing is traveling faster than the air moving underneath it, wherein the speeding up of the air over the wing will cause the pressure to drop such that faster moving air over the wing exerts less pressure than the slower air beneath it, thereby resulting in upward push, or lift. There are mainly four controls pilots use to maneuver helicopters: collective pitch control, throttle control, anti-torque control, and cyclic pitch control. The collective pitch control, the primary control for both altitude and power, is a lever that moves up and down to change the pitch angle of the main rotor blades equally across all blades, and may be linked to the throttle to automatically alter the power based on changes in the pitch lever such that increases in pitch angle cause increases in angle of attack leading to increase in lift and drag, which leads to decrease in rotor and engine rpm (and vice versa for pitch angle decrease). The throttle control, as used in conjunction with the collective pitch control above, may be twisted in either the outboard or inboard direction to increase or decrease the rotor rpm, respectively. The anti-torque control comprises pedals linked to operate a pitch change mechanism is the tail rotor's gearbox, thereby offsetting the torque that may vary with given flight conditions. Lastly, the cyclic pitch control is a stick-type device that controls the direction of flight by tipping the virtual plane of rotation in the desired direction.

Currently, the predominant design of helicopter blade attachment to a rotor mast's hub is via horizontal flapping hinges and vertical hinges. The flapping hinges permit the blades to move in a vertical plane, so that the angle of attack of each blade is decreased when the advancing blade flaps up and is increased when the retreating blade flaps down, so that this combination of flapping may equalize the lift in stationary hover while the collective pitch controls the height off the ground and cyclic pitch provides the vertical tilting of the rotor disk for controlling the pitch and roll, which then translates into horizontal velocity. The vertical hinges permit each blade to move back and forth in the plane of rotation while simultaneously dampening out vibrations and absorbing the effect of acceleration or deceleration. Many helicopters are designed with an additional wing specifically for counteracting the torque produced by the main rotor while in forward flight, thereby reducing reliance on and fatigue of the tail rotor but introducing more complexity in the form of oscillation known as tailwag.

Other alternative designs of helicopter rotor and blade systems include the use of a tail rotor to offset torque, dual stacked coaxial rotors, dual separate upright tandem (intermeshing or transverse) rotor systems (such as tiltrotor) such that some may be capable of vertical takeoff or landing (VTOL), stopping rotors that serve as a fixed wing for forward flight, folding rotors that collapse in streamwise direction to blend in with (or be stowed with) the fuselage contours, X-shaped rotors that rotate for takeoff and landing but are fixed for lift in flight, solid-state adaptive rotor systems, as well as possessing a tail having air escaping vents/fans with no tail rotor at all. However, tail rotors introduce undue design complexity into the system, through dynamic and significant systems of stress, due to the requisite long driveshaft presenting variable stress to the chassis of the aircraft.

Regardless of whether a tail rotor or no tail rotor (NOTAR) design is being used, the thrust being produced in a radial direction will counteract the vehicle's desire to spin opposite the force producing the lift. While tail rotors are normally driven by a long driveshaft that runs from the main rotor's transmission through the tail boom to the small rear transmission, the no tail rotor design employ a large fan (or vents) blowing spent air from the main rotor down the tail boom, where it may then escape through slots along the side of the tail boom thereby creating the aforementioned sideways force. The pilot is usually capable of adjusting either the rear rotor and transmission, or the tail boom's fan/vents, to vary the directional control.

Just as there are different design alternatives for the helicopter rotor and blade systems of attachment and operation, so too are there differences in the specific blade types that may be employed in each system. Rigid blades may firmly attach to a rotor hub via swiveling connections (feathering or pitch hinges), so that the blades may swivel (feather) as they rotate to allow steering. Semi-rigid blades may be firmly attached to a rotor hub via both feathering hinges and flapping (teetering) hinges, so that the blades may flap up and down. Fully articulated blades use both feathering and flapping hinges as well as drag hinges, so that the blades may move slightly ahead (lead) or behind (lag) their normal positions.

The main problems that currently exist within the prior art and are addressed by the present invention include rotor torque reaction (or effect), asymmetric rotor wash, and retreating blade stall. Torque effect is typically experienced by helicopters and single propeller aircraft wherein the action of the main rotor turns the fuselage in the opposite direction of the rotor's spin, such that the inclusion of tail rotors have become the common configuration to counter this motion. Rotor wash, or downwardly directed gusts of air, may cause wake turbulence and/or become high velocity surface winds causing loose debris thereunder to scatter at high speeds while twisting any workers/payloads suspended from ropes below the helicopter. Lastly, retreating blade stall is a phenomenon wherein the retreating rotor blade possesses a lower relative blade speed and, when combined with an increased angle of attack, causes a stall and loss of lift. This is due to the relative airspeed differential between the advancing and retreating blade tips, which may also apply to the tail rotor, which has collective for total thrust in addition to cyclic pitch control and typically automatically accounts for that differential given a specific airspeed. For now, any difference in lift is compensated for by the blade flapping and cyclic feathering (pitch angle changes) by the pilot, while the use of coaxial rotor designs may avoid these effects so long as the blades are advancing in opposite directions simultaneously.

However, while the use of coaxial rotor designs may offer some benefits like increased payload, increased ground safety, reduced noise, and higher operability or precision of control in smaller spaces, there is a significant increase in the mechanical complexity and weight of the whole system due to the two separate linkages and swashplates assemblies required for each system stacked atop one another on the mast. With a greater number of moving parts and complex interplay between the components, the coaxial rotor system is more likely to experience mechanical faults, breakages, or outright failure. Coaxial systems have also been criticized as being more prone to “whipping” of blades, or blade self-collision, as well as possessing a higher sensitivity to wind due to the use of fixed-pitch design wherein the blades cannot be rotated on their axes at different angles of attack. Avoiding this whipping, or self-collision, problem calls for large blade spacing, however, given current predominant designs such a solution requires the sacrificing of blade rigidity due the system being cantilevered. Additionally, another significant problem with a coaxial concentric driveshaft is that there is limited blade spacing within the system that is highly rigid in its design such that dynamic loads on the end of a lever, or shaft, cause excess wear on the topmost bearing. Other designs may include two rotor systems, facing the same direction, situated upon a single unloaded central drive shaft each having a direct drive motor, both rotors facing the same direction and utilizing the same drive motor situated between them that may act as an open differential, both rotors placed concentrically and operating in the same direction having a topmost bearing at the lowermost rotor and a single power input situated at their distal ends driving them both, or the rotor systems may be facing opposite directions wherein they would be in tension and have a single power source inputting power therebetween.

What is needed in the art is a contra-rotating coaxial rotor assembly that improves rigidity, reduces vibration and noise, reduces distance from dynamic loads to bearings, and exists as a scalable design having a longer average life span that is equally effective on a heavy lift helicopter requiring large blade spacing as on a smaller aircraft (or aquatic vessel), thereby improving ease of maintenance and field replacement. This needed assembly allows for the production of vehicles possessing noticeably superior efficiency, stability, precision of control and fewer points of failure when compared with traditional crafts, such as those mentioned above. Additionally, this needed contra-rotating assembly is less mechanically complex than most, if not all, of the aforementioned designs in that its components, or constituent assemblies, are capable of being unstacked more easily for replacement of individual parts or replacement of the central member upon which stacking occurs. Additionally, the instant design lessens the dynamic loads experienced by certain components, like the topmost bearing wherein excessive wear occurs more rapidly and requires more frequent replacement, as well as allowing for the expanded spacing of the rotor blades themselves.

### FIELD OF THE INVENTION

The present invention relates to a contra-rotating coaxial rotor assembly, and more particularly, to a contra-rotating coaxial rotor assembly that relates to aero (and aquatic) vehicles having, or requiring, a propeller (or propulsion) system, which is capable of more efficient flight, stability, precision in controls, and having fewer points of failure due in part to its improved rigidity, reduced vibrations, improved handling of dynamic loads, and scalable design applicable to a range of vehicle sizes, thereby also improving ease of maintenance or field replacement.

### SUMMARY OF THE INVENTION

The general purpose of the contra-rotating coaxial rotor assembly, described subsequently in greater detail, is to provide a contra-rotating coaxial rotor assembly which has many novel features that result in a contra-rotating coaxial rotor assembly which is not anticipated, rendered obvious, suggested, or even implied by prior art, either alone or in combination thereof. Some of the objectives of this contra-rotating coaxial rotor assembly include, but shall not be construed as limited to, the improvement of rigidity and reduction of vibration within the system as a whole, thereby increasing its overall operability and longevity, as well as specifically reducing the distance from dynamic loads to the bearings affected thereby, in addition to altering where such loads are experienced, such that components need less replacing throughout the system's lifetime. Additionally, the contra-rotating coaxial rotor assembly offers a scalable design that is equally as efficient and effective on heavy lift vehicles as it would be on smaller ones regardless of the requisite blade spacing called for by each design, as well as improving the ease and ability of operators and support members to maintain, replace, fix, or repair such assemblies both in a factory or a field setting.

According to one embodiment of the present invention, every component necessary for the rotor system to operate effectively is placed upon a singular preloaded central member and contained between at least two bearings capable of withstanding the combined loads experienced during operation, such as axial and thrust loads. This contemplated embodiment envisions, from the lowest point most proximal to the vehicle's frame, situated atop (or below in some embodiments) the aforementioned bearing, a power input source's transmission unit in operational engagement with the central member via some power translation unit (both typically comprised of gears and cogwheels), followed by one rotor system operationally engaged to a central contra-rotating gearbox which itself is operationally engaged to a second rotor system and capped with the aforementioned second bearing. This power transmission unit may be directly or indirectly connected to the aforementioned engine (or power source) output shaft, driveshaft, or equivalent structural element. The incorporation of thrust bearings along the central member and/or drivetrain disposed above the center of lift, in addition to the preload tension on the central member, acts to compress the drivetrain thereby creating more rigidity, diminishing vibration, and leading to extended longevity as forces are transferred to the airframe more efficiently, while offering easier replacement through simple unstacking and restacking of components. Unlike the aforementioned designs and layouts, which utilize dual coaxial orientations and/or centrally located power inputs, the placement of the power input at a position proximal the airframe (relative to most other components) offers less likelihood of mechanical failure due to external causes while the utilization of a contra-rotating gearbox disposed between the rotor assemblies to reverse the direction of rotation after it has effected one of the rotors translates the preload compression without unduly limiting blade space and rigidity, thereby offering a more efficient and effective method of vehicular lift and overall operation. In another contemplated embodiment herein, a turboshaft may be coaxially oriented with the present invention's gearbox, such that the thrust being generated therefrom could be used as additional lift alongside the power output from the contra-rotating system.

Describing one contemplated embodiment in more detail, as can be visualized in the figures submitted herewith, the central member is affixed to a base member (or a portion of the vehicle's frame/chassis) through which the engine's output shaft is, or shafts are, disposed such that gears or cogwheels may be placed upon the end(s) thereof. While the present, and any additionally contemplated, embodiment does not require a specific type of engine, it is understood that it may include gas (or combustion), electric, compressed air, or some hybrid combination thereof. Upon the central member may be stacked, in at least one contemplated embodiment, at least one power translation unit (typically a gear or cogwheel, such as straight gears and a planetary-sun gear combination, but may include a plurality of equivalent members), a thrust bearing, a rotor assembly, a contra-rotating gear assembly, another rotor assembly, another thrust bearing, and a mast (or “Jesus”) nut.

These rotor assemblies may each contain at least one length of mast with a rotor disposed thereon, wherein the rotor possesses at least one bladed member, and a friction-reducing crossed roller bearing device operationally coupled to both the individual rotor assembly and the contra-rotating gear assembly. Since the at least one power translation unit is in operational engagement with the power transmission unit, either directly or indirectly, the engine operates and converts power therefrom through these units into the one of the rotor assemblies. As this rotor assembly rotates in a first direction, the energy moves through the friction-reducing member into the contra-rotating gear assembly, which operates to reverse the orientation of said rotation from a first to a second direction as energy is transferred into the other rotor assembly through its own friction-reducing member. In this embodiment, the contra-rotating gear assembly is depicted as including two inwardly facing ring gears operationally engaging (or sandwiching) two bevel gears therebetween, which are affixed to protrusions of a collar, such as a stationary-keyed collar, affixed to the central member. These inwardly facing ring gears are depicted in the contemplated embodiments illustrated herein as being operationally distinguished from and coupled to the lengths of mast nearest thereto. The central member bears the preload tension and, once the mast nut locks into place, all of the components are kept in a state of compression, wherein the entire drivetrain will act as a solid member thereby offering reduced noise and vibration, improved rigidity and longevity, while controlling any unwanted additional forces that may otherwise act upon the assemblies. An additional improvement over past designs and productions is the simplified design of the present invention, which allows for easier maintenance through simple unstacking and replacement of parts before restacking.

Although this embodiment illustrates very specific numerosity and type of components, it is understood and contemplated that the gears, cogwheels, collars, and all members described herein may be replaced with, or operate in addition to, other types of gears, cogwheels, collars, bearings, friction-reducing devices, and all other structural elements described herein. While ring, bevel, straight, and planetary-sun gears are specifically mentioned within this example embodiment, they may be replaced or joined by zerol, worm, spiral, rack and pinion, cage and peg, helical, screw, or several other varieties of gears and cogwheels that are both mechanically and/or magnetically operable. Furthermore, these gears or cogwheels may possess complementary pitch angles between a range of zero degrees to ninety degrees, such that they may operationally engage one another without any gaps and without any wasted segments/teeth or space present therebetween. Likewise, while thrust bearings and crossed roller bearings are mentioned by name, as bearings capable of withstanding axial, moment, compression, twisting, and tilting loads, in addition to radial forces, other embodiments contemplate the addition of needle, uncrossed roller, crush washers, wear-surface bearings, and other equivalent bearings as well as lubricated bushings to achieve the same, or similar, functionality.

Furthermore, though specific numbers of bearings, gears, cogwheels, friction-reducing devices, collar protrusions, and like are mentioned throughout this and other sections, it is conceivable and should be understood that the present invention may be operational with at least one such member each. For instance, the collar may only possess a single protrusion upon which may be affixed a single gear or cogwheel, while the rotor members may each only possess at least one blade member, and the power translation and transmission units may each only possess at least one gear or cogwheel. Additionally, there may also be a plurality of each individual component present as well in any given contemplated embodiment considered herein, such as the aforementioned collar possessing a multitude of protrusions, each having one (or more) gears or cogwheels affixed thereto.

Another embodiment contemplated herein includes a central member that may be removable, detachable, or otherwise unlockable from the base member to which it is otherwise illustrated as being affixed. This capability may be due to complementary threaded portions, locking fingers and aperture portions, or other equivalent means of operational engagement as between at least one end of the central member and at least some area of the base member. The advantage of such an embodiment is the capability of removing, replacing, and/or swapping of either structural element without the added hassle of unstacking and removing every component thereon. This removal, replacement, swapping, or change of component may occur without causing any alteration of compression or tension experienced by the assembly.

Yet another embodiment contemplated herein includes having the mast nut placed at the bottommost portion of the drivetrain or even below the base member through which the central member is disposed, as opposed to the mast nut's typical location at the topmost endwise portion of the central member. Additionally, the central member in this embodiment may possess either a bolt head at the topmost endwise position or it may possess a secondary mast nut thereat to cap, and therefore contain and keep in compression, all components thereon.

Yet another embodiment contemplated herein includes at least one channel disposed within the space between the central member and the drivetrain assemblies wherein oil, grease, or some other lubricant may be pumped from a location proximal the vehicle's main body into, and throughout, the assemblies thereby keeping them in working order, which affects the wear and material fatigue experienced as well as each component's lifespan. This pumping of fluid may incorporate an additional mechanical component including a valve, port, line, or other elements, and/or the pumping of fluid may be accomplished via the utilization of specific forces already at work within the overall assembly, which may cause the lubricant to reach the uppermost portions thereof.

Yet another embodiment contemplated herein envisions the replacement of the contra-rotating gear assembly with a magnetic version thereof. One such example of how this may operate is the presence of a central magnetic sun gear, considered to be a high-speed rotor, operationally coupled with at least one magnetic planet carrier encompassing ferromagnetic pole pieces via at least one protrusion, or some equivalent means of connection. As the central magnetic sun gear rotates, so too will the peripheral magnetic planet carrier(s) rotate therearound, without straying in any radial direction due to the protrusion(s) keeping any such carriers at a set distance therefrom. The rotation and magnetization of the peripheral magnetic planet carrier(s) will in turn cause the contra-rotation of the magnetic ring gear encompassing all of these components, thereby achieving the same objective as the aforementioned embodiments; however, with substantially less loss of energy due to the frictionless nature of the energy transference. Like the aforementioned gears and cogwheels, while this contemplated embodiment may specify which type of magnetized gears are to be utilized, it is understood that each may be replaced or joined by zerol, worm, spiral, rack and pinion, cage and peg, helical, screw, or several other varieties of gears and cogwheels that operate mechanically and/or magnetically.

Yet another embodiment contemplated herein envisions an unstacked central member wherein the stack of assemblies comprising the drivetrain may be present adjacent to, and may be operationally engaged to, the preload tensed central member. While the central member in this embodiment may either be affixed, or removably affixed, to the base member, the stack contains at the position most proximal the vehicle's frame a friction-reducing member, such as crossed roller bearings, operationally engaged to both the frame and the lowest length of mast. A gear, or cogwheel, along that length of mast is operationally engaged with the power transmission unit, connected either directly or indirectly to the engine's output, and a power translation unit affixed to the central member. Further up the length of mast sits one of the rotor assemblies, having at least a single bladed member, and above that is another friction-reducing member operationally engaged to the contra-rotating gear assembly.

As in the previously described example embodiment, this contra-rotating gear assembly includes a keyed collar, or some equivalent component, having at least one protrusion extending radially therefrom, wherein at least one gear or cogwheel (such as a bevel gear) is affixed thereto, such that the upper and lower gears or cogwheels (such as ring gears) both operationally engage it. Moving beyond the contra-rotating gear assembly exists another friction-reducing member operationally engaged to both the contra-rotating gear assembly and the length mast thereabove, upon which sits another rotor assembly having at least a single bladed member. Capping the adjacent, non-central member drivetrain is a bearing and a second keyed collar, which is affixed to the central member but extends outward to encompass and encapsulate the adjacent stacked drivetrain, and a mast nut is lastly affixed to the central member thereby maintaining the state of compression along the entirety of the central member.

Although this embodiment has been described in fairly precise detail, as to the components and their order, it is not meant to suggest a lack of contemplated herein, such as the inclusion and placement along the drivetrain of different types and numerosity of gears, cogwheels, bearings, or friction-reducing members, the inclusion of a secondary or alternatively placed singular mast nut, as well as the inclusion of magnetized components in lieu of (or in addition to) the contra-rotating gear assembly.

Some such alterations of the present invention's embodiments described herein may include a magnetic gear arrangement and/or roller pinion gears, due to the increased efficiency resulting, in part, from the reduced friction within the system. As opposed to teeth intermeshing with teeth to transfer energy, the inclusion of magnetic teeth (or other protrusions/components) seeks to minimize energy lost through frictional physical contact between teeth, protrusions, or components. The inclusion of roller pinion gears will minimize the loss of energy by replacing the frictional effects of intermeshing teeth-on-teeth with the rolling friction of teeth about a cylindrical bar. Yet another alteration that is contemplated within the scope of the present invention is the inclusion of at least two parallel axes of roller barbells, or cogwheels resembling tooth jack shaft assemblies, having shafts disposed through at least two protrusions (or apertures therethrough) of the aforementioned collar within the contra-rotating gear assembly wherein rotation of one rotor assembly will cause the first set to rotate, which in turn rotates the second set in the opposite direction, which then causes the other rotor assembly to rotate in that same opposite direction. Yet another alteration contemplated herein may replace the directly engaging and/or coupling gears and cogwheels with indirectly engaging ones that operate via the inclusion of belt drives, chain drives, lead screws, shaft couplings, and equivalent structural elements which are used to interconnect the gears and cogwheels of the present invention as described herein.

Thus, has been broadly outlined the more important features of the contra-rotating coaxial rotor assembly so that the detailed description thereof that follows may be better understood and in order that the present contribution to the art may be better appreciated.

Objects of the contra-rotating coaxial rotor assembly, along with various novel features that characterize the invention are particularly pointed out in the claims forming a part of this disclosure. For better understanding of the contra-rotating coaxial rotor assembly, its operating advantages and specific objects attained by its uses, refer to the accompanying drawings and description.

### BRIEF DESCRIPTION OF THE DRAWINGS

### FIGS.

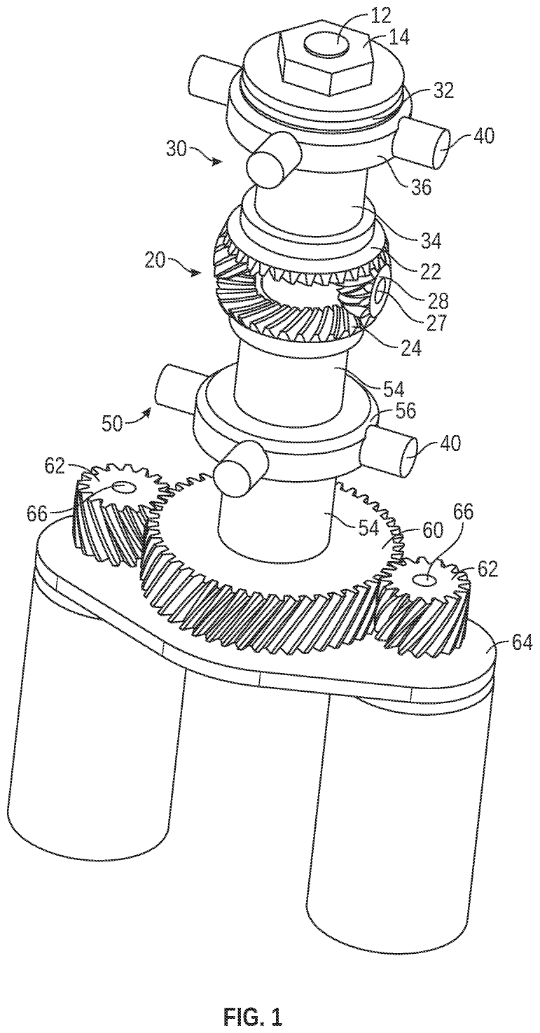

FIG. 1 is an isometric view of an example embodiment of the contra-rotating coaxial rotor assembly.

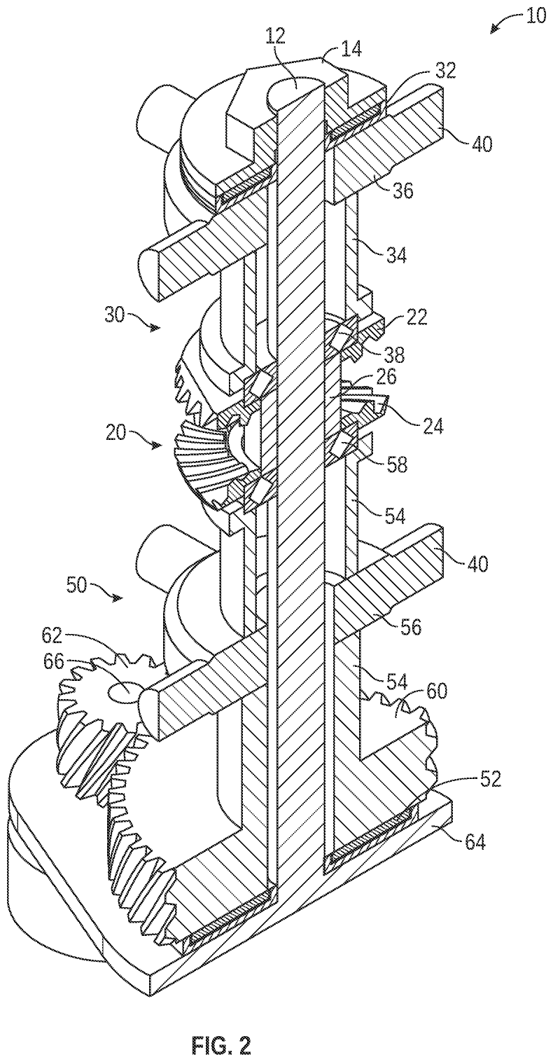

FIG. 2 is an isometric vertical crosscut side view of the same embodiment.

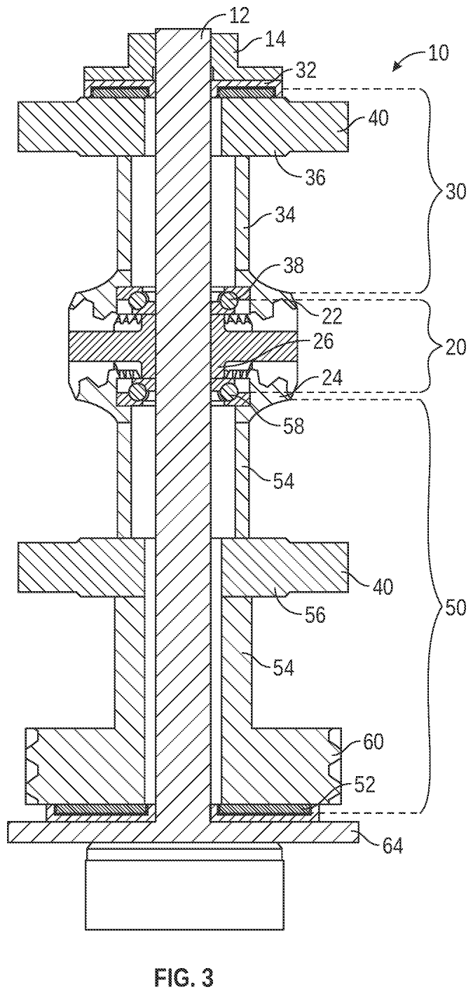

FIG. 3 is a vertical crosscut side view of a different embodiment.

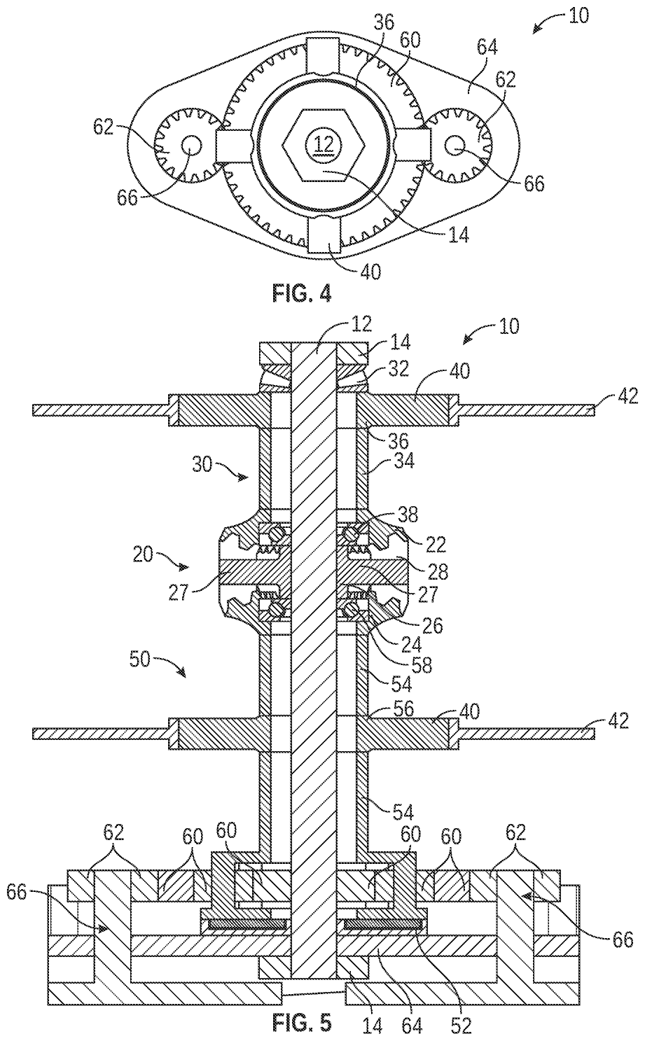

FIG. 4 is an aerial view of one embodiment of the contra-rotating coaxial rotor assembly.

FIG. 5 is a vertical crosscut side view of another embodiment.

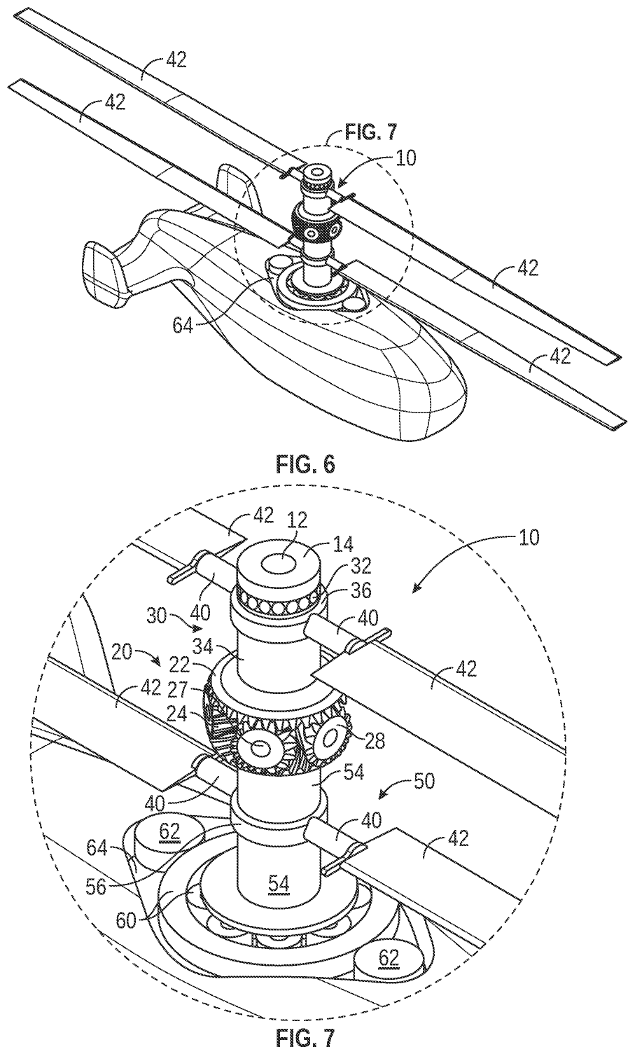

FIG. 6 is an isometric view of the embodiment shown in FIG. 5, as it would appear affixed to an aerial vehicle.

FIG. 7 is an isometric zoomed-in view of the embodiment pictured in FIG. 6.

### DETAILED DESCRIPTION OF THE DRAWINGS

With reference now to the drawings, and in particular FIGS. 1 through 7 thereof, of the contra-rotating coaxial rotor assembly example embodiments employing the principles and concepts of the present invention, generally designated by the reference number 10, will be described.

Referring to FIGS. 1 and 2, a first embodiment of the present contra-rotating coaxial rotor assembly 10 is illustrated in its entirety and vertically crosscut, while referring to FIG. 3, a second embodiment is depicted in like manner thereby allowing for a more complete perspective of every component within contra-rotating coaxial rotor assembly 10. The majority of structural elements of contra-rotating coaxial rotor assembly 10 may be divided into three main groupings, namely first and second rotor assembly 30, 50 and contra-rotating gear assembly 20 therebetween, all of which are stacked upon central member 12 and illustrated herein as being capped by mast nut 14.

Outside of these named assemblies, as illustrated in FIGS. 1 and 2, at least one engine output shaft 66 is depicted in each figure, extending through base member 64, wherein at least one power transmission cogwheel 62 is illustrated as being operationally coupled thereto while also being operationally engaged to power translation cogwheel 60, which is resting atop second bearing 52 (visible in FIG. 3), at the bottom of second rotor assembly 50 most proximal the vehicular frame (not shown) all of which is atop base member 64. As the engine (not shown) puts out power, the energy therefrom turns engine output shaft 66, thereby rotating the at least one power transmission cogwheel 62 present, which then operates to turn power translation cogwheel 60, and thus the entire contra-rotating rotor assembly 10, about central member 12.

As power translation cogwheel 60 rotates atop second bearing 52 (depicted herein as a thrust bearing), which itself sits directly atop base member 64, so too does the remainder of second rotor assembly 50 turn at the same rate therewith. This rotational energy translates throughout second rotor assembly 50 and partially into contra-rotating gear assembly 20, such that second length of mast 54, second rotor 56 (with blade member bases 40) disposed thereon, and second gear 24 (depicted herein as a ring gear) operationally engaged thereto all turn simultaneously with equivalent force. The presence of second friction reducer 58, disposed between central member 12 and second gear 24 (and operationally engaged to the latter), effectively negates the loss of any system energy caused by friction as between the components.

Once second gear 24 begins turning in a first direction, along with the remaining components of second rotor assembly 50, the entirety of contra-rotating gear assembly 20 operates to reverse the direction of rotation effecting first rotor assembly 30 within contra-rotating coaxial rotor assembly 20. Due to the rotation of second gear 24 in a first direction, cogwheels 28 (depicted herein as dual bevel gears) affixed to collar 26 (depicted herein as a keyed collar stationarily affixed to central member 12) via protrusions 27 (illustrated in FIG. 5) are forced to rotate along a perpendicular axis thereto, thereby causing rotation of first gear 22 (also depicted herein as a ring gear) in an opposite direction than second gear 24. Unlike previous aforementioned designs and systems that require separate drivetrains, stacks, or concentric coaxial setups, contra-rotating coaxial assembly's 10 utilization of contra-rotating gear assembly 20 accomplishes the counter-rotation of rotor blades in a more efficient and effective manner.

Due to the counter rotation of first gear 22 relative to second gear 24 and the entirety of second rotor assembly 50, the now-opposite rotational energy is transmitted through first friction reducer 38 to first rotor assembly 30, and all components therein including first length of mast 34 and first rotor 36 (with blade member bases 40) disposed thereon before reaching first bearing 32 (depicted herein as a thrust bearing). Thus, with first and second rotor assembly 30, 50 experiencing opposite rotational force, lift is produced while any torque that is created is either counteracted entirely or converted into additional lift.

As depicted in FIGS. 1 through 3, each of the second rotor assembly 50, contra-rotating gear assembly 20 and first rotor assembly 30 are stacked about central member 12, which is illustrated herein as affixed to base member 64 and capped by mast nut 14. Although not shown, central member 12 is contemplated as possessing a means of detachable affixation to base member 64, as aforementioned and described above. Once mast nut 14 operationally engages with central member 12, and is tightened into position thereon, the entirety of three main assemblies making up contra-rotating coaxial rotor assembly 10 are put into a state of preload tension, or compression, which yields an effect of the entire present invention operating as a singular unit as opposed to several individual elements, thereby causing a lower likelihood of lost or wasted energy throughout the system.

However, unlike in FIGS. 1 and 2, first and second gear 22, 24 of FIG. 3 are contemplated and illustrated as being operationally coupled to first and second length of mast 34, 54, respectively. While first and second friction-reducers 38, 58 still operate as previously discussed, the transmission of energy therethrough becomes secondary due to the more direct transmission offered by this alternatively contemplated design.

Referring next to FIG. 4, the embodiments of the present invention previously discussed are depicted from an aerial, top-down, perspective.

Referring next to FIG. 5, though partially similar in design to FIG. 3 in regard to both first and second gear 22, 24 relative to first and second length of mast 34, 54, the contemplated embodiment illustrated herein varies considerably from FIGS. 1 through 3. As previously discussed herein regarding additionally contemplated embodiments, FIG. 5 showcases a dual mast nut 14 design wherein central member 12 is removably affixable to the lowermost mast nut 14 (unlike the previous depictions wherein central member 12 is affixed to base member 64) either through the use of threaded portions, interlocking finger portions, or equivalents thereto (none of which are shown herein). Alternatively, uppermost mast nut 14 may be a bolt head affixed to central member 12 wherein both are removably affixable to, or through, base member 64. Additionally, though not depicted, this secondary mast nut 14 may also be a portion of base member (or air frame) 64. Also different from previous figures depicted herein is the inclusion of a plurality of power translation cogwheels 60 set up in a planetary system wherein one such cogwheel is still in contact with power transmission cogwheel 62. The other difference between this and previous figures, though minor, is the inclusion of a depiction of needle bearing 32 in lieu of the previously depicted thrust bearing, although (as mentioned herein) several other forms and types of bearings are contemplated for use within contra-rotating coaxial rotor assembly 10.

Referring lastly to FIGS. 6 and 7, an additionally contemplated embodiment of contra-rotating coaxial rotor assembly 10 is illustrated as it may actually exist affixed to an aerial vehicle. In these figures, as with the previous depictions of the instant invention, there are two engine output shafts 66 present through base member 64 wherein each is in operationally contact with one power translation cogwheel 62, which are themselves operationally engaged to multiple power translation cogwheels 60 sitting atop second bearing 52 (depicted herein as a thrust bearing). Beyond these differences, the additionally contemplated embodiment depicted in FIGS. 6 and 7 operates similarly to the previous embodiments depicted in FIGS. 1 through 5, wherein the rotational energy translated through power translation cogwheels 60 works to turn second rotor assembly 50, and all components therein except second bearing 52, in one direction while contra-rotating gear assembly 20 reverses the directionality of this rotational energy via the operational coupling of second and first friction reducers 58, 38 with second and first gears 24, 22, which are themselves operationally engaged with cogwheels 28 affixed to protrusions 27 of collar 26, which is itself affixed to central member 12. This, now reversed, rotational energy is then applied to first rotor assembly 30, and all components therein, such that second rotor 56 and first rotor 36 (both possessing blade member bases 40 and blade members 42 thereon) spin counter to one another, but at about equivalent speeds or rates. While, like FIGS. 1 through 4, first bearing 32 is the only component of first rotor assembly 30 in contact with mast nut 14, within this embodiment, and that of FIG. 5, it is contemplated as a needle (or conical) bearing. Otherwise, mast nut 14 is present atop contra-rotating coaxial rotor assembly 10, as in the previous figures, thereby producing a system that is in constant preload tension, or compression, however, it should also be reiterated that this topmost mast nut may be superfluous if, as aforementioned, central member 12 is manufactured with a bolt head.

1. A contra-rotating coaxial rotor assembly comprising:
a central member;
a first rotor assembly disposed endwise upon the central member;
a second rotor assembly disposed upon the central member spaced apart from the first rotor assembly;
a contra-rotating gear assembly coaxially disposed medial to the first rotor assembly and the second rotor assembly; and
wherein at least one end of the central member is capped with a head or operationally engages thereto and creates preload force throughout the contra-rotating coaxial rotor assembly;
wherein each aforementioned assembly is stacked upon the central member thereby forming a stacked drivetrain of force transference;
wherein rotation of the second rotor assembly in a first direction is translated to the first rotor assembly in a second direction by means of the contra-rotating gear assembly.

2. The contra-rotating coaxial rotor assembly of claim 1, wherein the contra-rotating gear assembly comprises:
at least one first gear operationally coupled to the first rotor assembly;
at least one second gear operationally coupled to the second rotor assembly;
a collar having at least one protrusion; and
at least one cogwheel affixed to the collar via the at least one protrusion, said at least one cogwheel operationally engaged to both the first and second gears;
wherein rotation of the at least one second gear in a first direction turns the at least one cogwheel, which then rotates, and thereby turns the at least one first gear in a second direction.

3. The contra-rotating coaxial rotor assembly of claim 1, wherein the first and second rotor assembly each comprises:
a bearing;
a length of mast;
a rotor disposed along the length of mast; and
a friction-reducer operationally engaged to each gear of the contra-rotating gear assembly;
wherein the rotational energy of the at least one gear will be transmitted to the length of mast, and rotor thereon, through the friction-reducer.

4. The contra-rotating coaxial rotor assembly of claim 3, wherein the second rotor assembly further comprises:
at least one power translation cogwheel;
wherein the rotational energy of the at least one power translation cogwheel will be transmitted to the second length of mast, and second rotor thereon, as well as to the contra-rotating gear assembly through the second friction-reducer.

5. The contra-rotating coaxial rotor assembly of claim 4, further comprising:
at least one power transmission cogwheel aligned coplanar to, and operationally engaged with, the at least one power translation cogwheel;
wherein the at least one power translation cogwheel is operationally engaged with at least one power transmission cogwheel, or gear, that is directly connected to, and driven by, the output shaft from an electric, combustion, compressed air, or hybrid engine.

6. A contra-rotating coaxial rotor assembly of claim 5, further comprising:
a member base, positioned adjacent to both the at least one power translation cogwheel and the at least one power transmission cogwheel, operationally engaged with the central member, having at least one threadable or lockable aperture therethrough;
wherein the central member enters the member base aperture and threads or locks into place, such that the central member and all parts thereon are individually removable and replaceable within the contra-rotating coaxial rotor assembly;
wherein the member base possesses at least one aperture for at least one engine output shaft to protrude therethrough and operationally couple to the at least one power transmission cogwheel.

7. The contra-rotating coaxial rotor assembly of claim 1, further comprising:
at least one mast nut disposed upon either end of the contra-rotating coaxial rotor assembly and operationally engaged to the central member;
wherein the mast nut locks the assembly, and each individual assembly and component thereof, in place along the central member thereby keeping every component disposed thereon in a state of compression.

8. The contra-rotating coaxial rotor assembly of claim 1 wherein the design of first and second gears as well as the at least one cogwheel of the contra-rotating gear assembly resembles at least one gear, or cogwheel, selected from a group comprising:
straight gears, spiral gears, spur gears, planetary gears, sun gears, zerol gears, worm gears, barbell gears, rack and pinion gears, roller pinion gears, cage and peg gears, bevel gears, helical gears, flat gears, ring gears, crown gears, tooth jack shaft gears, miter gears, screw gears, and magnetic variations thereof.

9. The contra-rotating coaxial rotor assembly of claim 5, wherein the at least one power transmission cogwheel and the at least one power translation cogwheel resembles at least one gear, or cogwheel, selected from a group comprising:
straight gears, spiral gears, spur gears, planetary gears, sun gears, zerol gears, worm gears, barbell gears, rack and pinion gears, roller pinion gears, cage and peg gears, bevel gears, helical gears, flat gears, ring gears, crown gears, tooth jack shaft gears, miter gears, screw gears, and magnetic variations thereof.

10. The contra-rotating coaxial rotor assembly of claim 3 wherein the first and second friction-reducers are capable of supporting moment loads, tilting loads, and radial forces, such as via crossed roller bearings, uncrossed roller bearings, lubricated bushings, or equivalents thereof.

11. The contra-rotating coaxial rotor assembly of claim 2 wherein the at least one cogwheel of the contra-rotating gear assembly possess a pitch angle between the range of 0 degrees to 90 degrees.

12. The contra-rotating coaxial rotor assembly of claim 11 wherein the first and second gears of the contra-rotating gear assembly each possess a complementary pitch angle relative to the at least one cogwheel.

13. The contra-rotating coaxial rotor assembly of claim 3 wherein the first and second bearings are axial plane bearings or rotary bearings, such as thrust or needle or conical bearings, designed for withstanding thrust and load bearing as well as twisting caused by gears and cogwheels motion.

14. The contra-rotating coaxial rotor assembly of claim 2 wherein each of the at least one cogwheel is affixed to the collar via each of the at least one protrusion extending radially therefrom.

15. The contra-rotating coaxial rotor assembly of claim 2 wherein the collar allows for simultaneous rotation of the contra-rotating gear assembly with the mast while it and the at least one protrusion therefrom remain stationary, such as via a shaft, keyed, or central member collar.

16. The contra-rotating coaxial rotor assembly of claim 1 wherein the first and second rotor assembly each possess at least one blade member, whereby contra-rotation of these members will create lift while either offsetting at least a portion of the torque produced or converting said portion of torque into additional lift.

17. The contra-rotating coaxial rotor assembly of claim 1 further comprising:
an oil pump affixed to the airframe capable of driving oil, grease, or other lubricants up a channel disposed between the central member and the stacked assemblies thereupon.

18. The contra-rotating coaxial rotor assembly of claim 1, wherein the contra-rotating gear assembly comprises:
at least one first gear operationally coupled to the first rotor assembly;
at least one second gear operationally coupled to the second rotor assembly;
a collar having at least one protrusion;
at least one cogwheel; and
at least one cogwheel shaft affixed to the collar via the at least one protrusion, operationally engaged to both the at least one cogwheel and either the at least one first gear or the at least one second gear;
wherein the at least one cogwheel shaft is affixed to the collar via apertures in the at least one protrusion thereof;
wherein rotation of the at least one second gear in a first direction turns the at least one cogwheel, via its operationally engaged cogwheel shaft, which then rotates surrounding cogwheels and thereby turns the first gear in a second direction, via its operationally engaged cogwheel shaft.

19. The contra-rotating coaxial rotor assembly of claim 1 wherein belt drives, chain drives, shaft couplings, and/or lead screws are used in conjunction with, or in lieu of, all of the gears and cogwheels of the contra-rotating coaxial rotor assembly's individual assemblies, such that direct operational coupling and engagement of said gears and cogwheels is replaceable with indirect operational coupling and engagement.
